(19) United States
(12) Patent Application Publication
(10) Pub. No.: US 2005/0273405 A1
(43) Pub. Date: Dec. 8, 2005

(54) Method and system fro making a conditional event binding on purchasers and vendors

(76) Inventor: Perry Chen, New Orleans, LA (US)

Correspondence Address: Keith M. Landry;Jones Walker, 50th Floor, 201 St. Charles Avenue, New Orleans, LA, 70170-5100, US

(21) Appl. No.: 10/946,521

(22) Filed: Sep. 20, 2004

Related U.S. Application Data
(60) Provisional application No. 60/577,280, filed on Jun. 4, 2004.

(51) Int. Cl. G06F 17/60

(52) U.S. Cl. 705/35

(57) ABSTRACT

The present invention relates to a method and system for selling a conditional event over a network such as the Internet, and in particular, to a method and system for selling a conditional event that provides that the sale of the event shall become binding on the buyer and the vendor upon the satisfaction of some pre-defined criteria which include a pre-defined time period specified by the vendor. The conditional event may include a concert, sporting event, staged event, charter travel, a commitment to perform an achievement or the like, and the pre-defined criteria may include a specified level of total number of sales, a specified level of total sales income or other pre-defined conditions. The system provides that prospective buyers can make their purchases by accessing a website, and the vendor shall become obligated to produce the event upon the satisfaction of the pre-defined criteria. The system further permits the vendor to automatically charge the buyer's credit card account upon the satisfaction of the pre-defined criteria.

### CROSS-REFERENCE TO RELATED APPLICATION

This application claims the benefit of U.S. Provisional Patent Application No. 60/577,280, filed Jun. 4, 2004. The subject matter of that application is incorporated by this reference.

### BACKGROUND OF THE INVENTION

1. Field of the Invention

The present invention relates to a method and system for selling a conditional event over a network such as the Internet, and in particular, to a method and system for selling a conditional event that provides that the sale of the event shall become binding on the buyer and the vendor upon the satisfaction of some pre-defined criteria which include a pre-defined time period specified by the vendor. The conditional event may include a concert, sporting event, staged event, charter travel, a commitment to perform an achievement or the like, and the pre-defined criteria may include a specified level of total number of sales, a specified level of total sales income or other pre-defined conditions. The system provides that prospective buyers can make their purchases by accessing a website, and the vendor shall become obligated to produce the event upon the satisfaction of the pre-defined criteria. The system further permits the vendor to automatically charge the buyer's credit card account upon the satisfaction of the pre-defined criteria.

2. Description of the Related Art

Traditionally, the production of an event can require significant expense and risk. An event, such as a concert, requires the vendor, usually the event promoter, to coordinate venues, talent, promotions, advertising and other related event planning services. Usually, the vendor incurs significant expense in covering this overhead and accepts an amount of risk in return for the potential profit from the event. It is not uncommon for events to fail to generate revenue sufficient to cover the expenses and compensate for the work and financial risk of the vendor. Sometimes, in anticipation of insufficient revenue, vendors will choose to “cut their losses” by canceling an event and refunding the event purchase price to ticket holders. In either case, the outcome is unsatisfactory to the vendor.

Similarly, the performance of an achievement, such as designing a new product, requires the product development company to coordinate personnel, resources, market research and other research and development and related product services. Again, as in the case of the concert promoter, the company incurs significant risk and expense, and it is not uncommon for the new product to generate insufficient revenue or the development process to be terminated prematurely due to the anticipation of insufficient revenue.

Under this traditional system, many events and achievements are considered too risky or cumbersome to attempt. Inevitably, it is probable that a potentially successful event or achievement will not be attempted because of the risk inherent in this traditional system that the event or achievement will not be profitable.

Due to the emergence of the Internet, the traditional system of product purchasing and the market experience of vendors and buyers have vastly changed. The benefits of the Internet for vendors include the increase in the amount of available buyers, and the decrease of many traditional overhead expenses. In turn, potential buyers have access to more vendors and more products and are able to shop 24 hours a day. Additionally, the rise of e-commerce has brought with it many new and exciting ways for vendors and buyers to do business.

The use of the Internet has also been established to create efficiencies in relation to the billing and payment for the purchase of goods and services. The widespread use of credit and debit cards and other online credit and debit services has allowed remote online transactions to flourish with added speed and security. In many instances such transactions are instantaneous, as vendors communicate with the credit institutions over communications networks to verify a buyer's identity and credit worthiness, and to have a buyer's charges approved or rejected in relation to the purchase of products or services.

Another feature of credit card transactions commonly used is for the vendor to perform an “authorize only” transaction. In such a transaction the amount is not charged to the buyer at the time of authorization but rather the buyer's credit card company authorizes the future charge of a specific amount of funds. This authorization guarantees payment to the vendor from the credit card company if, and when, such a charge is submitted. This method is widely used by car rental companies and hotels as an alternative to requiring a cash deposit.

Thus, there is a need to supplement the traditional event production system with a dynamic system that minimizes vendor risk by providing that the sale of the event shall become binding on the buyer and the vendor only upon the satisfaction of some pre-defined criteria specified by the vendor. Such a system would utilize the benefits of “authorize-only” credit card transactions to ensure efficiency and guarantee payment to the vendor upon satisfaction of the pre-defined criteria. Such a system would also allow vendors to offer a broader variety of events to the public by creating an environment where events that were previously too risky or too cumbersome for a vendor to consider hosting can now be offered at limited risk to the vendor.

### SUMMARY OF THE INVENTION

The present invention relates to a method and system for selling a conditional event over a network such as the Internet that provides that the sale shall become binding on the buyer and the vendor upon the occurrence of some pre-defined criteria which include a pre-defined time period set by the vendor. It can be appreciated by one of ordinary skill in the art that any event that the system can create an obligation on the buyer and seller instantaneously upon the satisfaction of the pre-defined criteria could be hosted with the system. In addition to traditional events, the system could also be used for the hosting of “achievements”. Such achievements may include for example, an agreement by a group to perform some achievement such as “A video game company will agree to design a new baseball video game if 100,000 units of the game can be sold for $60 by Jan. 1, 2005” or “Team X will attempt to climb Mount Everest if ten sponsors are obtained at $1,000 per sponsor.” The latter achievement shows how in one embodiment the invention can be used as a binding fundraiser for achievements in which no product or service is directly delivered to the buyer, but interest in the achievement is ascertained through the present invention. Throughout the specification, any reference to the term “event” can be appreciated by one of ordinary skill in the art to also include an “achievement” as such term is defined herein.

The core benefit of the present invention is that because of the conditionally binding nature of the purchases, the system dynamically and perfectly gauges true market demand for the vendor's event. Of particular importance is the fact that by setting their pre-defined criteria, vendors can offer events that would have been considered too risky or cumbersome to attempt under the traditional system. Thus, the present invention allows a much greater number of events to be offered to the public.

In operation, the system provides that buyers can participate in a conditional event sale by accessing a website from remote terminals. It can be appreciated by one of ordinary skill in the art that a buyer purchases a conditional event for purposes of the system by agreeing to the terms and conditions of the conditional event sale that include having a specific dollar amount authorized by the buyer's credit card company for future payment to the vendor in the case that the pre-defined criteria are satisfied. The system permits the vendor to instantly charge the buyer's credit card account upon the satisfaction of the pre-defined criteria.

In the event that the pre-defined criteria are satisfied in the pre-defined time period, all of the buyers are instantly charged. At that point, the vendor has the obligation to produce the event, and tickets, e-tickets or purchase confirmations are made available to the buyer. As can be appreciated from the description set forth below the system of the present invention can be used to sell events that are either ticketed in the traditional way or not.

In the event that the pre-defined criteria are not met in the pre-defined time-period, no refunds are necessary because the buyers' credit cards were never charged, only authorized. At that point, the vendor has no obligation to produce the event.

Another feature of the present invention includes the ability of a vendor to sell two or more conditional events simultaneously while having to only produce those events that achieve the desired threshold of demand as reflected in the pre-defined criteria. This “linked-event” feature allows vendors to have buyer demand dictate which of the linked events occur. For example, a concert for the same band could be scheduled on the same night in two or more cities, with only the one best satisfying the vendor's pre-defined criteria becoming binding on the buyer and the vendor.

Many of the other possible features and embodiments of the present invention are rooted in the conditional event sale terms and conditions set by the vendor. The main component of these terms and conditions is the pre-defined criteria that state the factors that will determine if the sale of the conditional event shall become binding on the buyer and the vendor.

These and other objects and features of the present invention will become apparent from the following Detailed Description and the accompanying drawings.

### BRIEF DESCRIPTION OF THE DRAWINGS

For a further understanding of the features and advantages of the present invention, reference should be made to the following Detailed Description taken in conjunction with the accompanying drawings wherein:

FIG. 1 is a block diagram of a website of the present invention.

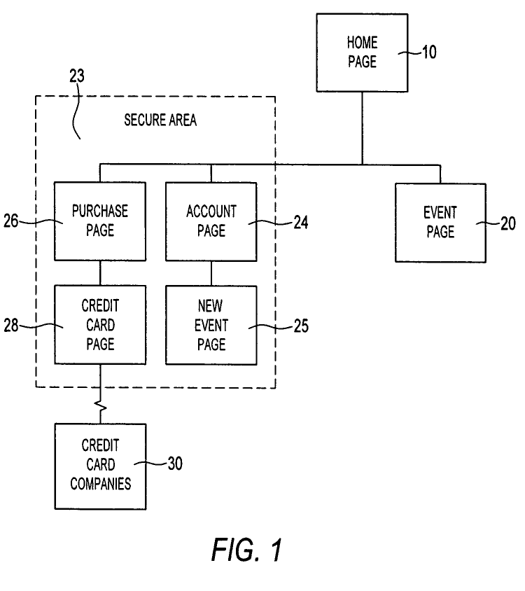

FIG. 2 is a block diagram showing the process of the present invention from the perspective of a buyer of an event.

FIG. 3 is a block diagram showing the process of the present invention from the perspective of a vendor of an event.

### DETAILED DESCRIPTION OF THE PREFERRED EMBODIMENT

The website of the present invention is hosted on a server having a database for storing information relating to posted events and collecting purchase information received from buyers as further described below. The website can be accessed by buyers and vendors over the Internet from remote terminals and computer systems. The website has a public, unsecured, area and a secure area 23. Generally, the public, unsecured area includes posted information relating to upcoming events and permits prospective buyers to view the information relating to such listings. The secure area 23 permits buyers or vendors to create private accounts and permits buyers to enter their credit card information and to make transactions. As can be further appreciated from the description set forth below, the website can be hosted by either the actual vendor of the events or through a third party intermediary that maintains a website for selling events on behalf of multiple vendors.

The public area of the website consists of a home page 10. The home page is accessible by all prospective buyers and vendors visiting the website. The home page includes general information relating to the website and postings of upcoming events. It also includes a log-in field for buyers and vendors to access their personal accounts. The home page also includes a search field that buyers may use to search the event listings according to specified criteria such as by the type of event, the name of the event, the artist, the location or the vendor. Such listed events may include a concert, sporting event, stage event, charter travel or other event. Such listed events could also include the introduction of a new product by a company such as “a video game company agreeing to design a new baseball video game if 100,000 units of the game can be sold for $60 by Jan. 1, 2005”. Also, the invention may also be used as a conditionally binding fundraiser for events where no good or services are provided to the buyer, but interest in the event is ascertained. In such cases the vendor is simply committing themselves to performing the event upon the satisfaction of the vendor's pre-defined criteria. For example, such listed events could include the proposed achievement of some pre-defined goal such as “a group of explorers agreeing to attempt to climb Mount Everest if ten sponsors are obtained at $1,000 per sponsor.”

From the home page 10, a prospective buyer may link to the webpage for a specified event 20 if the buyer has particular interest in such event. The event page 20 displays a detailed explanation of the event, the scheduled date and time of the event and information relating to the pricing and seating of the event, if applicable. The event page 20 also displays the commercial terms and conditions relating to the conditional sale of the event and a statement of the pre-defined criteria set by the vendor for the event that must be achieved in order for the vendor to be obligated to produce or perform the event. Such pre-defined criteria include the pre-defined time period for the sales of the event to be conducted and may also include a specified level of total number of sales, a specified level of total sales income or other pre-defined conditions. Other commercial terms displayed on the event page 20 may include other information regarding the artist or venue, if applicable. The event pricing structure information displayed on the event page 20 may include typical multi-tiered pricing for select seating or early purchases and may also include information relating to price discounts offered for certain purchases. The event page 20 may also permit a prospective buyer to view seating arrangements and any other information applicable to the event as desired by the vendor.

From the home page 10, the buyer or vendor may also access their account page 24. The account page 24 of each buyer or vendor is located on the secure area of the website 23 and may be accessed by the buyer or vendor only by entering their account identification and password. The account page 24 will be accessible by a buyer or vendor only after the buyer or vendor has created an account with the website.

Within the account page 24, the buyer or vendor may view the feature referred to herein as the “status of satisfaction feature” of the present invention. This feature permits a buyer or vendor to monitor the status of the pre-defined criteria relating to a conditional event, to the extent permitted by the vendor. For example, if the pre-defined criteria relates to a total number of sales, the status of satisfaction feature will display information in either textual or graphical form showing the number of sales as of such date and time. Alternatively, if the pre-defined criteria relates to a level of total sales income generated by the event, the status of satisfaction feature will display the level of total sales income authorized by credit card companies for buyers as of such date and time. The information viewed over the status of satisfaction feature of the present invention is referred to as the “status of satisfaction information” herein.

A buyer is able to view such status of satisfaction information to the extent permitted by the vendor. Depending on the terms and conditions of the conditional sale, the vendor may restrict the information relating to an event displayed over the status of satisfaction feature by choosing various levels of transparency for the display of the status of satisfaction information to buyers in relation to the vendor's event. For example, a vendor may elect to have a completely blind conditional sale where buyers are not permitted to monitor the satisfaction of the pre-defined criteria through the status of satisfaction feature. Alternatively, a vendor may elect to have a partially or completely transparent sale. In one embodiment of a partially transparent conditional sale, the vendor may allow buyers to monitor status of satisfaction information that is only updated every 24 hours. In a fully transparent conditional sale, buyers would be able to monitor up-to-the-minute status of satisfaction information.

As an additional feature, a vendor may elect to have certain status of satisfaction information displayed on the home page 10 or event page 20. For example, a vendor may wish to display on the event page 20 the message “only 4 more tickets need to be sold” for a particular conditional event to become binding. A vendor may elect to display different status of satisfaction information to buyers through their account page 24 as compared to the status of satisfaction information made available over the home page 10 or event page 20 to the public.

In addition to status of satisfaction information, the account page 24 may also communicate other event or account related information to the buyer or the vendor, as discussed below.

From a vendor's account page 24, a vendor may access a new event page 25 where the vendor may create a new listing for a conditional event that the vendor desires to offer for sale. As further described herein, the information submitted by the vendor over such new event page 25 to create the new listing includes a description of the type of event, the pre-defined criteria including a pre-defined time period applicable to the sale, other applicable terms and conditions, the pricing structure for the event and any additional information relating to the event that the vendor desires to be included in the listing. After such information has been submitted, the vendor has the opportunity to review and correct such information. If such information is correct, the listing will be included on an event page 20 and accessible by prospective buyers that access the website.

From the home page 10, a buyer may access the event page 20 if the buyer desires to get further information about an event. If the buyer then wishes to purchase the event, the buyer will select the purchase option link on the event page 20 and will enter the purchase page 26.

The purchase page 26 permits a prospective buyer to select the number of tickets or product to be purchased, the type of ticket or product to be purchased, and other choices, if applicable. The buyer is also permitted to view the terms and conditions that shall apply to the conditional sale of the event. By purchasing the event, the buyer is agreeing to those terms and conditions including having the purchase amount authorized by its credit card company utilizing an “authorize only” transaction. From the purchase page 26, the buyer may enter credit card page 28 to initiate a transaction.

On the credit card page 28, there is a prompt area that requires the buyer to enter their credit card and other information to be used to authorize the transaction.

The system of the present invention is interfaced with various credit card companies 30. Once the buyer's credit card information is entered, the system communicates with the buyer's credit card company over a communication network to receive authorization for a future charge. The buyer's credit card company must approve the authorization of future charges before the transaction will be approved by the system. This method of securing payment is in wide use in the credit card industry. Although credit cards are the most common method of payment, one of ordinary skill in the art can appreciate that other mechanisms of payment may be used with the website including debit cards or other payment mechanisms that can guarantee future payment of pre-authorized transactions.

The credit card company 30 processes the authorization request and transmits an “approved” or “declined” message to the website. The system then immediately notifies the buyer of whether the credit card company has either approved or declined the authorization.

If the charge is authorized, at this point, the buyer and the vendor become bound by the conditional event sale terms and conditions. The buyer is bound to pay the purchase price for the event and the vendor is bound to produce or perform the event upon the satisfaction of the pre-defined criteria.

Also, upon confirmation of the credit card authorization, the host database is updated by the system to reflect the transaction. The account page 24 for the buyer and the account page 24 for the vendor are updated to reflect the transaction.

Through the additional linked-event feature of the present invention, vendors have the ability to list two or more conditional events simultaneously while having to only produce those events that achieve the desired threshold of demand as reflected in the pre-defined criteria. This linked-event feature allows vendors to have buyer demand dictate which of the linked events occur. For example, a concert for the same band could be scheduled on the same night in two or more cities, with the one best satisfying the vendor's pre-defined criteria being the one staged. As another example, a vendor might set its pre-defined criteria as “most ticket sales income as of Jul. 1, 2005”, and the vendor would only be obligated to produce the concert that had generated the most ticket sales income as of Jul. 1, 2005.

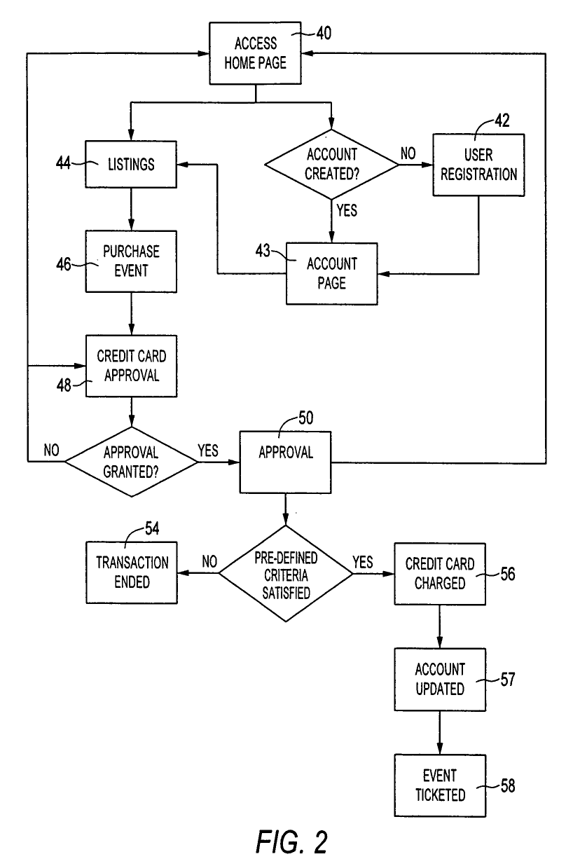

The process of the present invention from the perspective of the buyer is shown in greater detail in FIG. 2. The first step is for the buyer to access the home page 40 from the buyer's remote terminal and enter the public area of the website. The home page includes a search field that buyers may use to search the event listings 44 according to specified criteria such as by the type of event, the name of the event, the artist, the location or the vendor. The home page also includes a log-in field for buyer's to access their individual account page 43. If the buyer has an account already set up with the website, the buyer may log-in to the buyer's account page 43 by entering its account identification and password. If the buyer does not have an account, the buyer may register with the website by entering information and creating a new account 42. Once an account is established, the buyer may then access its personal account page 43 where status of satisfaction information, account information and information relating to events purchased and monitored are displayed. The account page also includes a search field that buyers may use to search the event listings 44.

Alternatively, if the buyer does not have an account or the buyer elects not to access their account page, the buyer may begin viewing information regarding listed events directly by linking to the event listings 44 from the home page either through a search or a selection of a category.

If the buyer is interested in an event, the buyer will link to that event's event page for further information relating to the event, including information explaining the vendor's pre-defined criteria including the pre-defined time period set for the sale of the conditional event. If the buyer then wishes to purchase the event, the buyer will select the purchase option on the event page and will be prompted to log-in prior to entering the purchase page. If the buyer does not have an account, the buyer may register with the website and create an account, before being forwarded to the purchase page.

Once on the purchase page, the buyer will select the details relating to their purchase order, such as number of tickets, seating choices, and preferred delivery methods in order to purchase the event 46. The buyer then may proceed to the credit card submission page to obtain credit card approval 48. The Buyer then submits its credit card and corresponding information. Once the buyer's credit card information has been entered, the credit card is processed for authorization approval via a communication link with the buyer's credit card company. The credit card company will either approve or decline the credit card authorization. If the credit card authorization is declined, the buyer is returned to the credit card submission page. The buyer may then review the information just submitted to determine if there was an error or may try another credit card. Otherwise, the buyer may return to the home page 40 or exit the website.

If the credit card authorization is approved, the buyer is notified that the authorization was successful 50. The buyer may then return to the home page 40 and begin the process all over for another event if desired or the buyer may return to the buyer's account page 43 or the buyer may exit the website.

After each authorized transaction, the system will update the database with respect to the applicable event. For example, if the pre-defined criteria relates to a total number of sales then the number of sales just completed shall increase the current count for the total sales number. If the pre-defined criteria relates to a total sales income amount, the total sales income amount will be increased by the revenue from the sales completed. After each authorized transaction the status of satisfaction information available to buyers and vendors will be updated as specified in the terms and conditions of that conditional event's sale.

At the expiration of the pre-defined time period, the system will check to determine whether the pre-defined criteria have been satisfied. If the pre-defined criteria are not fulfilled upon the expiration of the pre-defined time period, then the buyer's credit card is not charged and the transaction is ended 54. Also, the vendor is not obligated to produce the event.

If the pre-defined criteria are fulfilled at any time prior to the expiration of the pre-defined time period, then, at such time, the buyer's credit card account is charged 56. The buyer's account page is then updated to reflect the completion of the transaction 57. The buyer is then issued an e-ticket, ticket by mail, receipt or other purchase confirmation 58. The vendor is then obligated to host the event as specified in the terms and conditions of the conditional sale.

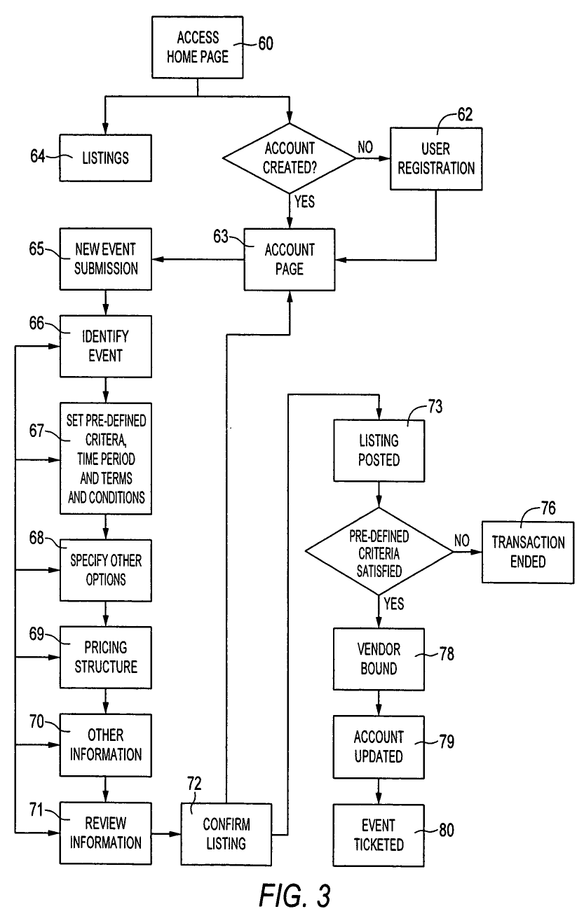

The process of the present invention from the perspective of the vendor is shown in greater detail in FIG. 3. The vendor may access the website from a remote terminal similar to the buyer and enter the website at the home page 60. The home page includes a log-in field for vendors to access their account page 63. If the vendor has already established an account with the website, the vendor may log-in to their account page 63. If the vendor is a new user or has otherwise not yet established an individual account, the vendor may register with the website by entering information and creating a new account 62. Once an account is established the vendor may then access the vendor's private account page 63. On the vendor's account page, the vendor may view status of satisfaction information relating to any events listed by the vendor and other information relating to their account. From the home page, the vendor may also access the event listings on the website and view either its events or the events listed by other vendors 64.

If the vendor desires to list a new event, the vendor will enter the new event listing submission page 65 from the vendor's account page 63. In order for the vendor to submit information for a new listing, the vendor must be a registered user of the website. In order to list a new conditional event, the vendor must identify the type of event such as whether the event is a staged event, charter service, physical achievement, product development or the like 66. The vendor then selects the pre-defined criteria applicable to the event, including a pre-defined time period during which transactions will be accepted, and further sets the terms and conditions applicable to the conditional sale 67. The vendor then selects other criteria options applicable to the event such as the linked-event feature, as applicable 68. The vendor then selects the pricing structure for the event such as the various pricing tiers and possible discounts to early buyers or other such pricing related options 69. Finally, the vendor provides information relating to the event such as the date, time, and location of the event, and other relevant information, as applicable 70. After the vendor enters all of the listing information, the vendor has the opportunity to review the listing information and confirm its accuracy 71. If there are any corrections that should be made, the vendor may return to any of the new event submission steps to make any revisions that are necessary. If all of the information submitted is accurate, the vendor confirms the listing 72. At this point, the listing is submitted to the website and the vendor may return to the vendor's account page 63 if desired. The listing will be posted on the website together with any other listings from such vendor or any listings from any other vendors at the date and time selected by the vendor.

Once the event listing is posted, the system will begin accepting conditional sale transactions from buyers 73.

At the expiration of the pre-defined time period, the system will check to determine whether the pre-defined criteria have been satisfied. If the pre-defined criteria are not fulfilled by the pre-defined time period, the vendor is not obligated to produce or perform the event and the transaction is ended 76. If the pre-defined criteria are satisfied at any time prior to the expiration of the pre-defined time period, then, at such time, all of the pre-authorized buyers of the event are charged, and at that moment the vendor becomes obligated to host the event 78. The account pages of the buyers and the vendor are then updated to reflect the satisfaction of the pre-defined criteria 79. Finally, the buyer is issued an e-ticket, ticket by mail, receipt or other purchase confirmation 80, as applicable, and the vendor produces or performs the event.

In an alternative embodiment of the present invention, the vendor has an option to make the conditional event binding and accept all purchases made by buyers even if the pre-defined criteria are not satisfied. For this option to be available to the vendor, a detailed explanation of such option must be included in the conditional event sale terms and conditions that are reviewed and agreed to by the buyer for that particular event. In exercising such option, the vendor may accept the current level of conditional event sales and bind itself to produce the event and charge the buyers at that point. For a vendor, this is more efficient than re-listing an event with criteria that are at lower levels.

Although a preferred embodiment of the present invention has been described in the foregoing Detailed Description and has been illustrated in the accompanying Figures, it will be understood that the invention is not limited to the embodiment disclosed but is capable of numerous modifications without departing from the scope of the invention claimed. Also, although the methods disclosed herein have been described and shown with reference to particular steps performed in a particular order, it will be understood that these steps may be combined, sub-divided or re-ordered to form an equivalent method without departing from the teachings of the present invention. Accordingly, unless specifically indicated herein, the order and grouping of the steps is not a limitation of the present invention.

1. A method for selling a conditional event online, the method comprising:
providing for a website, buyers accessing the website over a communication network from remote computers;
providing for the display of information relating to an event over the website, the occurrence of the event conditioned on pre-defined criteria set by a vendor of the event, the pre-defined criteria being required to be satisfied in order for the vendor to be obligated to produce the event, the other pre-defined criteria and the commercial terms of the sale being displayed to the buyers;
providing for the receipt of a purchase request for an event from a buyer and credit card information from the buyer in order to facilitate a pre-authorized purchase transaction for the buyer; and
upon the satisfaction of the pre-defined criteria, providing for the charging of the buyer's credit card account to complete the purchase transaction, the vendor being obligated to produce the event.

2. The method of claim 1 wherein the period for a buyer to purchase a conditional event over the website extends for a pre-defined period of time set by the vendor of the event.

3. The method of claim 1 wherein, upon completion of the purchase transaction, the buyer is issued a ticket for the event.

4. The method of claim 1 wherein, upon completion of the purchase transaction, the buyer is issued a receipt confirming the purchase of the event.

5. The method of claim 1 wherein the vendor may offer to sell one or more conditional events, each conditional event having its own pre-defined criteria, the vendor becoming bound to produce only those events that achieve the pre-defined criteria.

6. The method of claim 1 further comprising providing for a secure area of the website, the secure area including a private account page accessible by a vendor that has created an account with the website.

7. The method of claim 6 wherein the vendor may view information updated to reflect the completion of a transaction.

8. The method of claim 6 wherein the vendor may view the status of the progress toward satisfaction of the pre-defined criteria with respect to a particular event on the vendor's private account page.

9. The method of claim 6 wherein the vendor may create a listing of information for a new event on a new event page accessible by the vendor from a vendor's private account page, the information displayed on the website and sales of the event completed.

10. A method for purchasing tickets to a conditional event online for a buyer, the method comprising:
accessing a public area of a website to view information concerning a future conditional event;
accessing a secure area of a website for entering credit card information in order to purchase a conditional event, the occurrence of the event being conditioned on the satisfaction of certain pre-defined criteria set by a vendor, the other commercial terms being preset;
transmitting a purchase request for an event and credit card information over the website, the credit card information further transmitted to a credit card company over a network in order to facilitate a pre-authorized purchase transaction for the buyer;
upon the satisfaction of the pre-defined criteria, charging the buyer's credit card account to complete the purchase transaction.

11. The method of claim 10 wherein the period to purchase an event over the website extends for a pre-defined period of time set by the vendor of the event.

12. The method of claim 10 wherein, upon completion of the purchase transaction, the buyer is issued a ticket for the event.

13. The method of claim 10 wherein, upon completion of the purchase transaction, the buyer is issued a receipt confirming the purchase of the event.

14. The method of claim 10 wherein one or more buyers may make purchases of one or more conditional events offered by the vendor, the buyer's credit card account being charged for only those events in which the pre-defined criteria have been satisfied.

15. The method of claim 10 further comprising accessing a secure area of the website, the secure area permitting the buyer to create a private account page.

16. The method of claim 15 wherein the completion of a purchase transaction is confirmed on the buyer's private account page.

17. The method of claim 15 wherein the buyer may view the status of the progress toward satisfaction of the pre-defined criteria for an event of interest on the buyer's private account page, but only to the extent permitted by the vendor.

18. A system for conducting the online sale of a conditional event, the system comprising:
means for displaying information relating to a conditional event over a website, the vendor's obligation to produce the event conditioned on the satisfaction of pre-defined criteria set by the vendor of the event, the other commercial terms being preset;
means for performing a credit card pre-authorization transaction upon the request of a buyer to purchase the event; and
means for determining when the pre-defined criteria have been satisfied and, upon satisfaction, automatically charging the buyer's credit card account for the purchase, to complete the purchase transaction the vendor becoming obligated to produce the event.

19. The system of claim 18 wherein the period for a buyer to make a purchase of a conditional event over the website extends for a pre-defined period of time set by the vendor of the event.

20. The system of claim 18 further comprising means for issuing a ticket for an event to a buyer upon completion of the purchase transaction.

21. The system of claim 18 further comprising means for issuing a receipt confirmation for an event to a buyer upon completion of the purchase transaction.

22. The system of claim 18 further comprising means for monitoring the satisfaction of the pre-defined criteria and displaying information relating to the pre-defined criteria over a private account page.

23. A computer useable medium and computer readable code embodied on the computer useable medium for conducting the online sale of a conditional event, the computer readable code comprising:
a first code segment providing for the display of information relating to a conditional event over a website, the vendor's obligations to produce the event conditioned on the satisfaction of pre-defined criteria set by the vendor of the event, the other commercial terms being preset;
a second code segment providing for performing a credit card pre-authorization transaction upon the request of a buyer to purchase the event; and
a third code segment providing for determining when the pre-defined criteria have been satisfied and, upon satisfaction, automatically charging the buyer's credit card account to complete the purchase transaction for the purchase and the vendor becoming obligated to produce the event.

24. The computer useable medium and computer readable code of claim 23 wherein the period for a buyer to purchase a conditional event over the website extends for a pre-defined period of time set by the vendor of the event.

27. The computer useable medium and computer readable code of claim 23 further comprising computer useable medium and computer readable code for monitoring the satisfaction of the pre-defined criteria.

28. A method for selling a conditional event online, the method comprising:
providing for a website, buyers accessing the website over a communication network from remote computers;
providing for the display of information relating to an event over the website, the occurrence of the event conditioned on pre-defined criteria set by a vendor of the event, the vendor having an option to agree to produce the event even though the pre-defined criteria have not been satisfied, the other pre-defined criteria and the commercial terms of the sale being displayed to the buyers;
providing for the receipt of a purchase request for an event from a buyer and credit card information from the buyer in order to facilitate a pre-authorized purchase transaction for the buyer; and
upon the vendor exercising its option to agree to produce the event even though the pre-defined criteria have not been satisfied, providing for the charging of the buyer's credit card account to complete the purchase transaction, the vendor being obligated to produce the event.
